(19) United States
(12) Patent Application Publication
(10) Pub. No.: US 2017/0096341 A1
(43) Pub. Date: Apr. 6, 2017

(54) METHOD OF MASS PRODUCING FEW-LAYER GRAOHENE POWDERS

(71) Applicant: SHANDONG YUHUANG NEW ENERGY TETHNOLOGY CO., LTD, HEZE (CN)

(72) Inventors: XIN CHEN, HEZE (CN); SHUANG XIAO, HEZE (CN); SHENGWEI WANG, HEZE (CN); YING WANG, HEZE (CN); CHENGLONG ZHAO, HEZE (CN); HECUN DONG, HEZE (CN); BING ZHANG, HEZE (CN)

(73) Assignee: SHANDONG YUHUANG NEW ENERGY TETHNOLOGY CO., LTD, HEZE (CN)

(21) Appl. No.: 14/873,146

(22) Filed: Oct. 1, 2015

(51) Int. Cl. C01B 31/04

(52) U.S. Cl. CPC C01B 31/0446

(57) ABSTRACT

The present invention relates to a method for producing few-layer graphene powders. An electrolytic solution is introduced as a coagulation floating agent wherein graphene is able to be suspended thereon, which prevent the graphene from coacervation.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

Technical Field

The present invention relates to the field of micro- and nano-materials producing technology in energy fields, particularly relates to a method of mass manufacturing of few-layer graphene powders.

Background Technique

Graphene is a mono-layer plane film consisted of hexagonal honeycomb lattices formed by carbon atoms having Sp² hybridized orbitals, which is a two-dimensional material as thick as one carbon atom, and is a base unit for carbon materials of a plurality of dimensions (such as zero-dimensional fullerenes, one-dimensional nano carbon tubes and three-dimensional graphite). Graphene has excellent physical and chemical properties, and has been increasingly used in the fields of transparent conductive films, nano-electronics (transistors, transistor circuits interconnected memory semiconductors), conductive inks, solar cells, lithium batteries, super capacitors, sensors and bio-medicines.

One of the prior art methods that is likely to achieve mass production of graphene powders is by applying Hummers method (Preparation of Graphitic Oxide, Journal of the American Chemical Society, 80, 1339) combined with a reductive solvent: first, graphite is treated with a controlled-temperature and intercalated oxidation method, wherein oxidized graphite is produced. Oxide of graphenes are then stripped by ultrasound, and the graphene is produced by reducing oxide of graphenes with reducing agents such as hydrazine hydrate, sodium borohydride, etc. Generally, amounts of the reducing agents may be increased to achieve a better reducing effect, and the concentration of the oxide of graphenes may be increased to rapidly achieve a larger amount of the graphene powders, which lead to significant coacervation of the graphene powder during production, and result in worse-than-normal reducing effect. Therefore, there is a need to develop a method of producing high-quality graphene powders under mass scales, with friendly operation and low cost, and free of the coacervation of the graphene powders.

### DESCRIPTION OF THE INVENTION

The present invention addresses deficiencies from prior art technologies, and provides a simple, rapid, and mass-scaled method for producing few-layer (10 layers or less) graphene powders, which addresses issues from prior art producing methods such as high likelihood of coacervation of graphene powders, poor conductivity, etc.

The present invention is achieved by the following technical solutions:

The method of producing the few-layer graphene powders, wherein its special feature is introducing a variety of electrolytes as a coagulated floating reagent for a graphene colloid solution, by which graphene is allowed to rapidly float on top thereof, and producing the graphene powders.

Accordingly, a method of producing the few-layer graphene powders in mass-scale of this present invention, consists of following steps:

(1) Oxidation of graphene: under an ice-cooling condition, mixing natural graphite with sodium nitrate, wherein a mixture is formed; then adding into the mixture successively with high-concentration sulfuric acid and potassium hypermanganate for reacting; adding deionized water into the mixture after the reaction and keeping it at 90-100° C. for 20-30 minutes; then adding hydrogen peroxide and the deionized water into the mixture, wherein an oxidized graphite solution with a bright yellow color is produced; then, applying centrifuged washes conducted alternatively by acid-washes and water-washes to said oxidized graphite solution with the bright yellow color until its PH=5-6, wherein a pure oxidized graphite solution is prepared; last, treating said pure oxidized graphite solution with ultrasound, wherein an oxide of graphenes solution is formed; and, preparing the oxide of the graphenes solution into a certain concentration.

(2) Reduction by hydrazine hydrate: adding the oxide of the graphenes solution with the hydrazine hydrate; then adding ammonia water until said solution reaches a pH of about 9-10, incubating it at 95° C., wherein a graphene colloidal solution is produced.

(3) Suction filtration of coagulated floating: mixing the graphene colloid solution and an electrolytic solution and allowing the solutions to be rested at a room temperature, wherein the electrolytic solution is applied as the coagulated floating reagent; collecting the graphene by a suction filtration, then washing the graphene with water and freeze-drying, wherein first graphene powders reduced by hydrazine hydrate were produced.

(4) Heated reduction treatment: placing the first graphene in a tube furnace under a nitrogen atmosphere, raising its temperature at a heating rate of 2-10° C./min, incubating it at 1000-1050° C. for 2 minutes to 3 hours; cooling it to the room temperature, grinding it, and dispersing it with the ultrasound in an organic solvent, baking it at 50-60° C. and drying to obtain second graphene powders.

Accordingly, yet another method of producing the few-layer graphene powders in mass-scale of this present invention, consists of the following steps:

(1) Oxidation of the graphene: under the ice-cooling condition, mixing every 50-100 g of the natural graphite with 25-50 g of the sodium nitrate, wherein the mixture is formed; then adding into the mixture with 1.15-2.3 L of the high-concentration sulfuric acid that has a mass fraction of 95-98%, and 150-300 g of the potassium hypermanganate; allowing the mixture to react for 1-2 hours before raising its temperature to 35° C. for 30-50 minutes; then adding 0.75-1.5 L of the deionized water into the mixture and keeping it at 90-100° C. for 20-30 minutes; adding 0.15-0.3 L of the hydrogen peroxide and 7-15 L of the deionized water into the mixture, wherein the oxidized graphite solution with the bright yellow color is produced; then, applying alternatively the acid-washes and the water-washes of the centrifuged washes to said oxidized graphite solution with the bright yellow color, until its PH=5-6, wherein the pure oxidized graphite solution is prepared; then, treating said pure oxidized graphite solution with the ultrasound of 100-500 HZ for 0.5-2 hours to form the oxide of the graphenes solution; preparing the oxide of the graphenes solution into the certain concentration between 0.1-5 mg/mL.

(2) Reduction by the hydrazine hydrate: adding the deionized water into said oxide of the graphenes solution, at approximately 1:1 ratio by volume or until the oxide of the graphenes solution is between 0.05-2.5 mg/mL; adding into the oxide of the graphenes solution with the hydrazine hydrate having its mass fraction between 40-80%, then adding the ammonia water having its mass fraction between 25-28%, which results in a mixed solution having pH=9-10, raising said mixed solution to 95° C. and incubating for 1-3 hours, wherein the graphene colloidal solution was produced.

Alternatively, the oxide of the graphenes solution of 0.05-2.5 mg/mL may be prepared directly after treated with the ultrasound. Preferably, an extra step of diluting is introduced, wherein said solution is first prepared into the certain concentration between 0.1-5 mg/mL, then is diluted by adding the deionized water at approximated 1:1 ratio by volume. Said diluting step allows the oxide of the graphenes to be further dispensed in said solution.

Preferably, the amount and the mass fraction of the hydrazine hydrate are determined by the amounts and the concentration of the oxide of the graphenes solution; and, the amount and the mass fraction of the ammonia water are calculated so that by adding said ammonia water, the oxidized graphene solution may reach the PH between 9-10. For example, for every 2 L of said oxide of the graphenes solution having the concentration of 0.5 mg/mL, adding 2 L of the deionized water, adding 1.4 mL of 50% the hydrazine hydrate while stirring, then adding 7 mL of 28% the ammonia water, wherein said mixed solution has pH=9-10; raising the mixed solution to 95° C. and incubating for 1 hour, wherein the graphene colloidal solution was produced.

(3) suction filtration of coagulated floating: using the electrolytic solution as the coagulated floating reagent, mixing the graphene colloid solution with the electrolytic solution, wherein the graphene colloid solution and the electrolytic solution have a volume-to-volume ratio of 1:1˜3, incubating at the room temperature for 0.5-2 hours, allowing the graphene to gradually conjugate and float on the top of the graphene colloid solution, collecting the graphene by the suction filtration, wherein the graphene was washed by water and freeze-dried, and first graphene powders reduced by the hydrazine hydrate are produced.

(4) Heated reduction treatment: placing the first graphene powders from last step in a tube furnace, raising its temperature under a nitrogen atmosphere at the heating rate of 2-10° C./min, and baking it at 1000-1050° C. for 2 minutes to 3 hours; cooling down said first graphene powders to the room temperature; grinding, and ultrasonic dispersing it with an organic solvent, and drying it at 50-60° C., wherein the second graphene powders were obtained.

The electrolytic solution may be water based solutions of sulfuric acid, hydrochloric acid, sodium hydroxide, potassium hydroxide, sodium nitrate, sodium sulfate, sodium chloride, sodium carbonate, or ammonium carbonate; wherein the mass fraction of the electrolyte solution is 1-8%, preferably, 5%.

Accordingly the present invention of the methods of producing the few-layer graphene powders in mass-scale, wherein the organic solvent may be alcohols, ketones, or aldehydes.

Accordingly, the first graphene powders is mixed with the organic solvent at the volume-to-volume ratio of 1:1-4, and dispersed by the ultrasound at 100˜500 HZ for 0.5˜2 hours.

Accordingly, the first graphene powders are grind until that no visible agglomerations of said graphene powders are presented.

Accordingly the present invention of the methods of producing the few-layer graphene powders in mass-scale, hydrazine hydrate reduced graphene powders, or the first graphene powders are characterized with 2-5 layers, its carbon-oxygen ratio is 9-15, a specific surface area of 232-346 m²/g, a conductivity of 100-403 S/m.

Preferably, the first graphene powders have the carbon-oxygen ratio of 11.90.

Accordingly the present invention of the methods of producing the few-layer graphene powders in mass-scale, hydrazine hydrate and heat reduced graphene powders, or the second graphene powders, are characterized with 3-7 layers, a superior capacity of crystallization, the carbon-oxygen ratio is between 80-95, the specific surface area of 271-393 m²/g, the conductivity of 1741-2766 S/m.

Preferably, the second graphene powders have the carbon-oxygen ratio of 86.72.

The advantages of the present invention are: the present invention applies the hydrazine hydrate to reduce a low-concentrated solution of the oxidized graphene, and to form the graphene colloidal solution, which prevents the graphene from coacervation; the present invention introduces acids, alkali, or salt electrolyte as the coagulated floating reagent, which allows rapid washes of the graphene, user-friendly operations, simplicity for mass productions, and potentials for large-scale industrial applications; the present invention utilizes low-concentrated solutions, wherein its process has insignificant impacts to environments, and wasted materials from this process contain small amounts of ions, which have low waste-treating costs.

### BRIEF DESCRIPTION OF THE DRAWINGS

FIG. 1 is a Raman spectroscopy diagram of hydrazine hydrate reduced graphene powders, and hydrazine hydrate reduced and heat treated graphene powders, respectively; wherein the hydrazine hydrate reduced graphene powders are represented by a solid line and the hydrazine hydrate reduced and heat treated graphene powders are represented by a dash line.

FIG. 2 is an X-ray photoelectron spectra (XPS) on C 1 s peak of hydrazine hydrate reduced graphene powders; wherein said graphene's C/O=11.90.

FIG. 3 is an X-ray photoelectron spectra (XPS) on C 1 s peak of hydrazine hydrate reduced and heat treated graphene powders; wherein said graphene powders' C/O=86.72.

FIG. 4 is a TEM diagram of hydrazine hydrate reduced graphene powders.

FIG. 5 is an atomic force (AFM) diagram (a) of hydrazine hydrate reduced graphene powders.

FIG. 6 is a thickness measurement diagram (b) of hydrazine hydrate reduced graphene powders; wherein the thickness thereof is 1.109 nm;

FIG. 7 is a TEM diagram of hydrazine hydrate reduced and heat treated graphene powders.

FIG. 8 is a scanning electron micrograph (SEM) diagram of hydrazine hydrate reduced and heat treated graphene powders.

### DETAILED DESCRIPTION OF EMBODIMENTS

### Embodiment 1

A process of producing few-layer graphene powders:

(1) Oxidation of graphene: Hummers Method was applied here, under an ice-cooling condition, mixing 50 g of natural graphite with 25 g of sodium nitrate, then adding 1.15 L of a high-concentration sulfuric acid, and 150 g of potassium hypermanganate; allowing reacting for 2 hours before raising to 35° C. for reacting for 50 minutes; then adding 0.75 L of deionized water and keeping at 90-100° C. for 20-30 minutes; adding 0.15 L of hydrogen peroxide and 7 L of the deionized water, wherein an oxidized graphite solution with the bright yellow color was produced; then, washing alternatively with 5% sulfuric acid and water during centrifuged washes, until no sulfuric ion left in the oxidized graphite solution and at PH=5-6, wherein a pure oxidized graphite solution was prepared; then, treating said pure oxidized graphite solution with ultrasound, and preparing oxide of graphenes solution with certain concentrations.

(2) Reduction by hydrazine hydrate: adding 2 L of the deionized water into 2 L of 0.5 mg/mL said oxide of the graphenes solution, adding 1.4 mL of the hydrazine hydrate having a mass fraction of 50% while stirring, then adding 7 mL of the ammonia water having the mass fraction of 28%, wherein said solution has pH=9-10, raising to 95° C. and incubating for 1 hour before cooling to 50° C., wherein the graphene colloidal solution was produced.

(3) Suction filtration of the coagulated floating: using the sulfuric acid having the mass fraction of 5% as the coagulated floating reagent, mixing 1 volume of the graphene colloid solution with 2 volume of the 5% sulfuric acid, incubating at a room temperature (25° C.) for 0.5 hours, allowing the graphene gradually conjugating and floating on the top of the mixed solutions, suction-washing with the deionized water and freeze-drying, wherein first graphene powders reduced by hydrazine hydrate were produced, which has 2-5 layers, a carbon-oxygen ratio of 11.90, a specific surface area of ˜242.4 m²/g, a conductivity of ˜225.7 S/m.

(4) Heated reduction treatment: placing the first graphene powders in a tube furnace, raising its temperature under a nitrogen atmosphere at a heating rate of 10° C./min, and maintaining at 1000° C. for 30 minutes; cooling down to the room temperature; then, grinding, and ultrasonically dispersing with alcohol or acetone, and drying at 50-60° C. wherein second graphene powders were obtained, which have 3-7 layers, the oxygen-carbon ratio of 86.72, the specific surface area of ˜309.4 m²/g, a conductivity of ˜1867.3 S/m.

### Embodiment 2

The process of producing the few-layer graphene powders:

(1) Oxidation of graphene: same as what is previously disclosed in Embodiment 1.

(2) Reduction by hydrazine hydrate: same as what is previously disclosed in Embodiment 1.

(3) Suction filtration of the coagulated floating: using 5% hydrochloric acid as the coagulated floating reagent, mixing 1 volume of the graphene colloid solution with 2 volume of the 5% hydrochloric acid, incubating at the room temperature (25° C.) for 1 hour, allowing the graphene gradually conjugating and floating on the top of the mixed solutions, suction-washing with the deionized water until chloride free, then freeze-drying, wherein the first graphene powders reduced by hydrazine hydrate were produced, which had the specific surface area of ˜346.1 m²/g, the conductivity of ˜370.7 S/m.

(4) Heated reduction treatment: placing the first graphene powders in the tube furnace, raising its temperature under the nitrogen atmosphere at the heating rate of 10° C./min, and maintaining at 1050° C. for 1 hour; cooling down to the room temperature; then, grinding, and ultrasonically dispersing with alcohol or acetone, and drying at 50-60° C., wherein the second graphene powders were obtained, which had the specific surface area of ˜350.1 m²/g, the conductivity of ˜2174.6 S/m.

### Embodiment 3

The process of producing the few-layer graphene powders:

(1) Oxidation of graphene: same as what is previously disclosed in Embodiment 1.

(2) Reduction by hydrazine hydrate: same as what is previously disclosed in Embodiment 1.

(3) Suction filtration of the coagulated floating: using 5% sodium hydroxide solution as the coagulated floating reagent, mixing 1 volume of the graphene colloid solution with 2 volume of the 5% sodium hydroxide solution, incubating at the room temperature (25° C.) for 1 hour, allowing the graphene gradually conjugating and floating on the top of the mixed solutions, suction-washing with the deionized water until PH=7, then freeze-drying, wherein the first graphene powders reduced by hydrazine hydrate were produced, which had the specific surface area of ˜270.1 m²/g, the conductivity of ˜168.1 S/m.

(4) Heated reduction treatment: placing the first graphene powder in the tube furnace, raising its temperature under the nitrogen atmosphere at the heating rate of 10° C./min, and maintaining at 1050° C. for 3 hours; cooling down to the room temperature; then, grinding, and ultrasonically dispersing with alcohol or acetone, and drying at 50-60° C., wherein the second graphene powders were obtained, which had the specific surface area of ˜273.4 m²/g, the conductivity of ˜2041.7 S/m.

### Embodiment 4

The process of producing the few-layer graphene powders:

(1) Oxidation of graphene: same as what is previously disclosed in Embodiment 1.

(2) Reduction by hydrazine hydrate: same as what is previously disclosed in Embodiment 1.

(3) Suction filtration of the coagulated floating: using 5% potassium hydroxide solution as the coagulated floating reagent, mixing 1 volume of the graphene colloid solution with 2 volume of the 5% potassium hydroxide solution, incubating at the room temperature (25° C.) for 1 hour, allowing the graphene gradually conjugating and floating on the top of the mixed solutions, suction-washing with the deionized water until PH=7, then freeze-drying, wherein the first graphene powders reduced by hydrazine hydrate were produced, which had the specific surface area of ˜301.3 m²/g, the conductivity of ˜355.8 S/m.

(4) Heated reduction treatment: placing the first graphene powder in the tube furnace, raising its temperature under the nitrogen atmosphere at the heating rate of 10° C./min, and maintaining at 1000° C. for 3 hours; cooling down to the room temperature; then, grinding, and ultrasonically dispersing with alcohol or acetone, and drying at 50-60° C., wherein the second graphene powders were obtained, which had the specific surface area of ˜393.7 m²/g, the conductivity of ˜1741.0 S/m.

### Embodiment 5

The process of producing the few-layer graphene powders:

(1) Oxidation of graphene: same as what is previously disclosed in Embodiment 1.

(2) Reduction by hydrazine hydrate: same as what is previously disclosed in Embodiment 1.

(3) Suction filtration of the coagulated floating: using 5% sodium nitrate solution as the coagulated floating reagent, mixing 1 volume of the graphene colloid solution with 2 volume of the 5% sodium nitrate solution, incubating at the room temperature (25° C.) for 2 hours, allowing the graphene gradually conjugating and floating on the top of the mixed solutions, suction-washing with the deionized water until PH=7, then frozen-drying, wherein the first graphene powders reduced by hydrazine hydrate were produced, which had the specific surface area of ˜271.2 m²/g, the conductivity of ˜353.5 S/m.

(4) Heated reduction treatment: placing the first graphene powders in the tube furnace, raising its temperature under the nitrogen atmosphere at the heating rate of 10° C./min, and maintaining at 1050° C. for 3 hours; cooling down to the room temperature; then, grinding, and ultrasonically dispersing with alcohol or acetone, and drying at 50-60° C., wherein the second graphene powders were obtained, which had the specific surface area of ˜318.3 m²/g, the conductivity of ˜1895.0 S/m.

### Embodiment 6

The process of producing the few-layer graphene powders:

(1) Oxidation of graphene: same as what is previously disclosed in Embodiment 1.

(2) Reduction by hydrazine hydrate: same as what is previously disclosed in Embodiment 1.

(3) Suction filtration of the coagulated floating: using the 5% sodium sulfate solution as the coagulated floating reagent, mixing 1 volume of the graphene colloid solution with 2 volume of the 5% sodium sulfate solution, incubating at the room temperature (25° C.) for 1 hour, allowing the graphene gradually conjugating and floating on the top of the mixed solutions, suction-washing with the deionized water until free of sulfuric ions, then freeze-drying, wherein the first graphene powders reduced by hydrazine hydrate were produced, which had the specific surface area of ˜271.1 m²/g, the conductivity of ˜214.0 S/m.

(4) Heated reduction treatment: placing the first graphene powders in the tube furnace, raising its temperature under the nitrogen atmosphere at the heating rate of 10° C./min, and maintaining at 1050° C. for 3 hours; cooling down to the room temperature; then, grinding, and ultrasonically dispersing with alcohol or acetone, and drying at 50-60° C., wherein the second graphene powders were obtained, which had the specific surface area of ˜319.3 m²/g, the conductivity of ˜2657.6 S/m.

### Embodiment 7

The process of producing the few-layer graphene powders:

(1) Oxidation of graphene: same as what disclosed in Embodiment 1.

(2) Reduction by hydrazine hydrate: same as what is previously disclosed in Embodiment 1.

(3) Suction filtration of the coagulated floating: using 5% sodium chloride solution as the coagulated floating reagent, mixing 1 volume of the graphene colloid solution with 2 volume of the 5% sodium chloride solution, incubating at the room temperature (25° C.) for 1 hour, allowing the first graphene gradually conjugating and floating on the top of the mixed solutions, suction-washing with the deionized water until free of chloride, then freeze-drying, wherein the graphene powders reduced by hydrazine hydrate were produced, which had the specific surface area of ˜232.8 m²/g, the conductivity of ˜266.1 S/m.

(4) Heated reduction treatment: placing the first graphene powders in the tube furnace, raising its temperature under the nitrogen atmosphere at the heating rate of 10° C./min, and maintaining at 1050° C. for 3 hours; cooling down to the room temperature; then, grinding, and ultrasonically dispersing with alcohol or acetone, and drying by baking at 50-60° C. wherein the second graphene powders were obtained, which had the specific surface area of ˜288.8 m²/g, the conductivity of ˜2766.3 S/m.

### Embodiment 8

The process of producing the few-layer graphene powders:

(1) Oxidation of graphene: same as what is previously disclosed in Embodiment 1.

(2) Reduction by hydrazine hydrate: same as what is previously disclosed in Embodiment 1.

(3) Suction filtration of the coagulated floating: using 5% sodium carbonate solution as the coagulated floating reagent, mixing 1 volume of the graphene colloid solution with 2 volume of the 5% sodium carbonate solution, incubating at the room temperature (25° C.) for 1 hour, allowing the graphene gradually conjugating and floating on the top of the mixed solutions, suction-washing with the deionized water until PH=7, then freeze-drying, wherein the first graphene powders reduced by hydrazine hydrate were produced, which had the specific surface area of ˜257.2 m²/g, the conductivity of ˜403.9 S/m.

(4) Heated reduction treatment: placing the first graphene powders in the tube furnace, raising its temperature under the nitrogen atmosphere at the heating rate of 10° C./min, and maintaining at 1050° C. for 2 minutes; cooling down to the room temperature; then, grinding, and ultrasonically dispersing with alcohol or acetone, and drying at 50-60° C., wherein the second graphene powders were obtained, which had the specific surface area of ˜271.1 m²/g, the conductivity of ˜2118.6 S/m.

### Embodiment 9

The process of producing the few-layer graphene powders:

(1) Oxidation of graphene: same as what is previously disclosed in Embodiment 1.

(2) Reduction by hydrazine hydrate: same as what is previously disclosed in Embodiment 1.

(3) Suction filtration of the coagulated floating: using 5% ammonium carbonate solution as the coagulated floating reagent, mixing 1 volume of the graphene colloid solution with 2 volume of the 5% ammonium carbonate solution, incubating at the room temperature (25° C.) for 1 hour, allowing the graphene gradually conjugating and floating on the top of the mixed solutions, suction-washing with the deionized water until PH=7, then frozen-drying, wherein the first graphene powders reduced by hydrazine hydrate were produced, which had the specific surface area of ˜260.7 m²/g, the conductivity of ˜100.2 S/m.

(4) heated reduction treatment: placing the first graphene powders in the tube furnace, raising its temperature under the nitrogen atmosphere at the heating rate of 10° C./min, and maintaining at 1050° C. for 3 hours; cooling down to the room temperature; then, grinding, and ultrasonically dispersing with alcohol or acetone, and drying at 50-60° C., wherein the second graphene powders were obtained, which had the specific surface area of ˜272.8 m²/g, the conductivity of ˜1854.6 S/m.

### Embodiment 10

The process of producing the few-layer graphene powders:

(1) Oxidation of graphene: the Hummers Method was applied here. under the ice-cooling condition, mixing 10 g of the natural graphite with 50 g of the sodium nitrate, then adding 2.3 L of the high-concentration sulfuric acid, and 300 g of the potassium hypermanganate; allowing reacting for 1 hour before raising to 35° C. for reacting for 30 minutes; then adding 1.5 L of the deionized water and keeping at 100° C. for 30 minutes; adding 0.3 L of the hydrogen peroxide and 15 L of the deionized water, wherein the oxidized graphite solution with the bright yellow color was produced; then, washing alternatively with the 5% sulfuric acid and water before centrifuging, until free of sulfuric ions and at PH 5-6, wherein a pure oxidized graphite solution was prepared; then, treating said pure oxidized graphite solution with ultrasound, and preparing the oxide of graphenes solution with certain concentrations.

(2) Reduction by hydrazine hydrate: adding 2 L of the deionized water into 2 L of 0.5 mg/mL said oxide of graphenes solution, adding 1.4 mL of the 50% hydrazine hydrate while stirring, then adding 7 mL of the 28% ammonia water, wherein said solution has pH=9-10, raising to 95° C. and incubating for 1 hour before cooling to 50° C., wherein the graphene colloidal solution was produced.

Suction filtration of the coagulated floating: using the 5% sulfuric acid as the coagulated floating reagent, mixing 1 volume of the graphene colloid solution with 2 volume of the 5% sulfuric acid, incubating at the room temperature (25° C.) for 0.5 hour, allowing the graphene gradually conjugating and floating on the top of the mixed solutions, suction-washing with the deionized water, then freeze-drying, wherein the first graphene powders reduced by hydrazine hydrate were produced, which had 3 layers, the carbon-oxygen ratio of 11.90, the specific surface area of ˜240 m²/g, the conductivity of ˜230 S/m.

(4) Heated reduction treatment: placing the first graphene powders in the tube furnace, raising its temperature under the nitrogen atmosphere at the heating rate of 2° C./min, and maintaining at 1025° C. for 2 hours; cooling down to the room temperature; then, grinding, and ultrasonically dispersing with alcohol, and drying at 50-60° C., wherein the second graphene powders were obtained, which had 5 layers, superior crystallizing capacities, the specific surface area of ˜312.3 m²/g, and the conductivity of ˜1869.6 S/m.

### Embodiment 11

The process of producing the few-layer graphene powders:

(1) Oxidation of graphene: the Hummers Method was applied here. under the ice-cooling condition, mixing 75 g of the natural graphite with 37 g of the sodium nitrate, then adding 1.7 L of the high-concentration sulfuric acid, and 225 g of the potassium hypermanganate; allowing reacting for 1.5 hours before raising to 35° C. for reacting for 40 minutes; then adding 1.1 L of the deionized water and keeping at 95° C. for 25 minutes; adding 0.22 L of the hydrogen peroxide and 10.5 L of the deionized water, wherein the oxidized graphite solution with the bright yellow color was produced; then, washing alternatively with 5% sulfuric acid and water before centrifuging, until free of sulfuric ions and at PH 5-6, wherein a pure oxidized graphite solution was prepared; then, treating said pure oxidized graphite solution with ultrasound, and preparing the oxide of the graphenes solution with certain concentrations.

Reduction by hydrazine hydrate: adding 2 L of the deionized water into 2 L of 0.5 mg/mL said oxide of graphenes solution, adding 1.4 mL of the 50% hydrazine hydrate while stirring, then adding 7 mL of the 28% ammonia water, wherein said solution has pH=9-10, raising to 95° C. and incubating for 1 hour before cooling to 50° C., wherein the graphene colloidal solution was produced.

Suction filtration of the coagulated floating: using the 5% sulfuric acid as the coagulated floating reagent, mixing 1 volume of the graphene colloid solution with 2 volume of the 5% sulfuric acid, incubating at the room temperature (30° C.) for 2 hours, allowing the graphene gradually conjugating and floating on the top of the mixed solutions, suction-washing with the deionized water, then freeze-drying, wherein the first graphene powders reduced by hydrazine hydrate were produced, which had 4 layers, the carbon-oxygen ratio of 11.90, the specific surface area of ˜245 m²/g, the conductivity of ˜250.4 S/m.

(4) Heated reduction treatment: placing the first graphene powders in the tube furnace, raising its temperature under the nitrogen atmosphere at the heating rate of 5° C./min, and maintaining at 1025° C. for 3 hours; cooling down to the room temperature; then, grinding, and ultrasonically dispersing with alcohol, and drying at 50-60° C., wherein the second graphene powders were obtained, which had 5 layers, the superior crystallizing capacities, the carbon-oxygen ratio of 87, the specific surface area of ˜316.7 m²/g, the conductivity of ˜1864.1 S/m.

### Embodiment 12

Because the few-layer graphene powders produced have similar characteristics, the Embodiment 1 was set as example, and analysis based thereon is provided as the following:

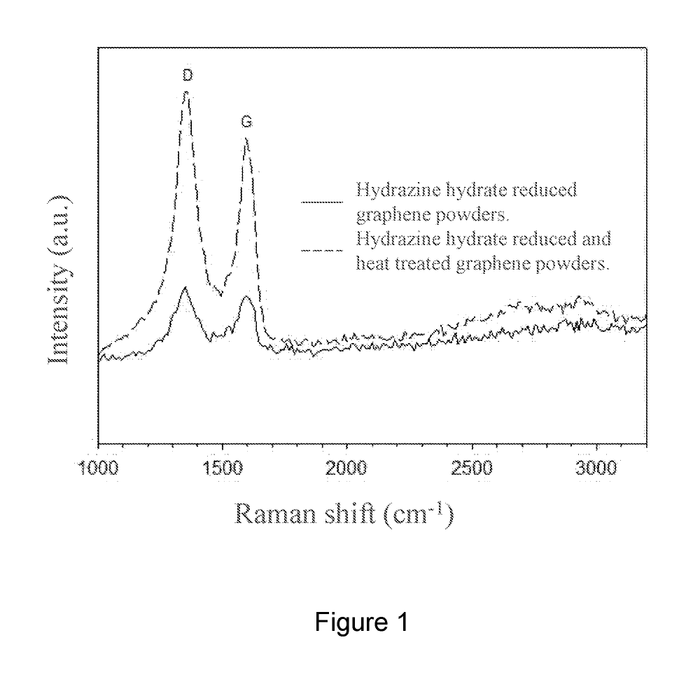

FIG. 1 is a Raman spectroscopy diagram for hydrazine hydrate reduced graphene powders and hydrazine hydrate reduced and heat treated graphene powders; wherein peaks D & G suggest that samples prepared by different processes both are the few-layer graphene powders that have the superior crystallizing capacities.

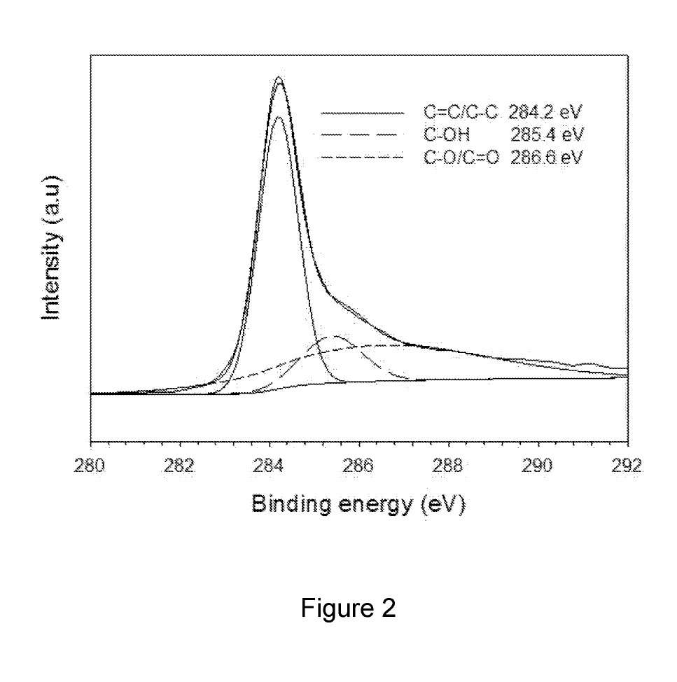

FIG. 2 is an X-ray photoelectron spectra (XPS) on C 1 s peak of the hydrazine hydrate reduced graphene powders; wherein said graphene powders' C/O (carbon-oxygen ratio)=11.90.

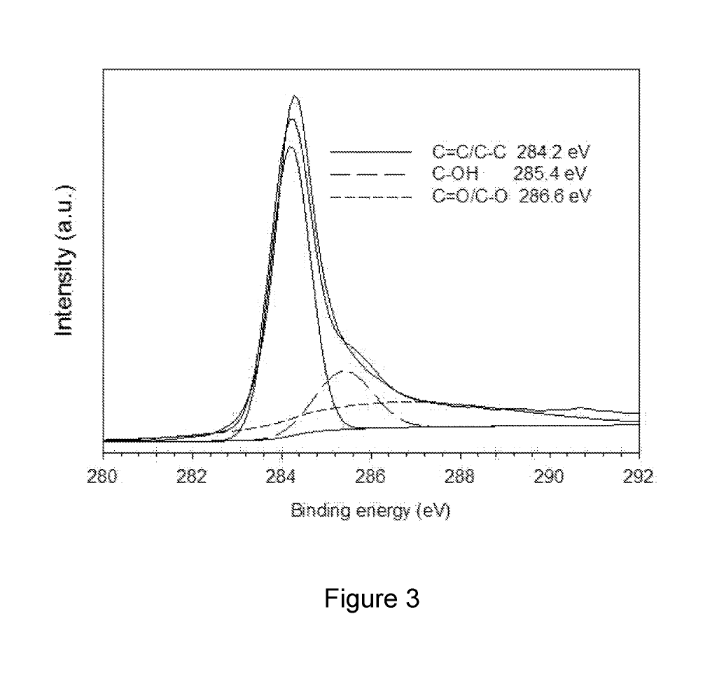

FIG. 3 is an X-ray photoelectron spectra (XPS) on C 1 s peak of the hydrazine hydrate reduced and heat treated graphene powders; wherein said graphene powders' C/O=86.72.

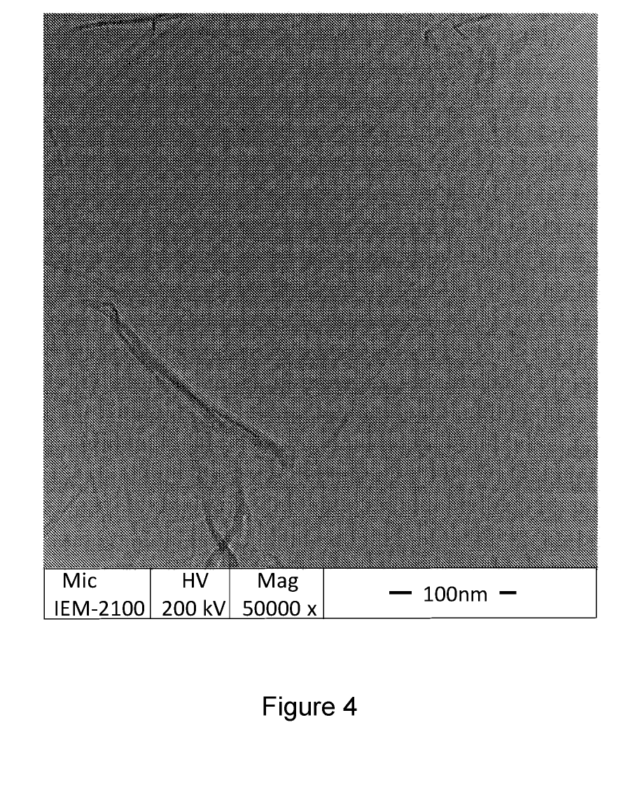

FIG. 4 is a TEM diagram of the hydrazine hydrate reduced graphene powders, which indicates that said graphene powders contain large amounts of the few-layer graphene.

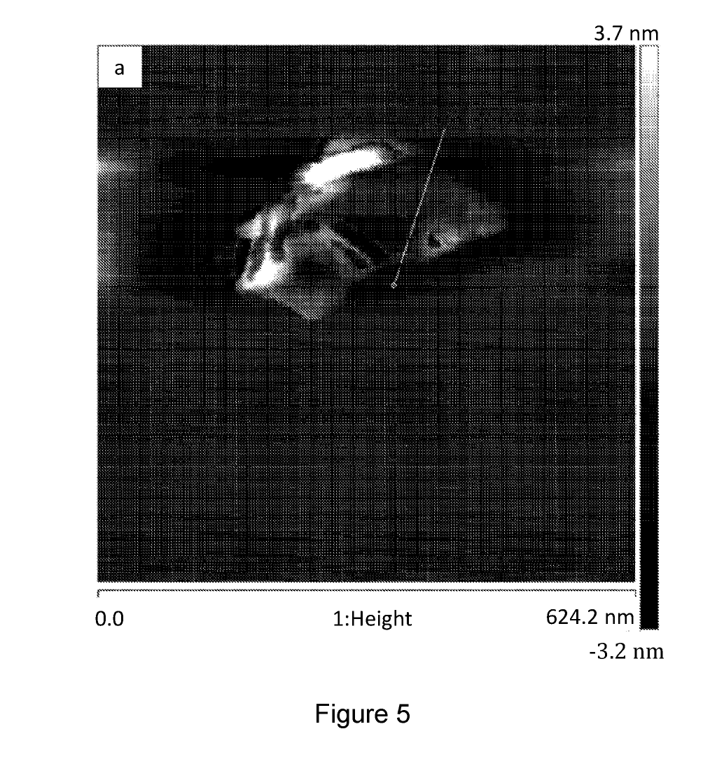

FIG. 5 is an atomic force (AFM) diagram (a) of the hydrazine hydrate reduced graphene powders, wherein said graphene powders contain large amounts of micro nano-planes.

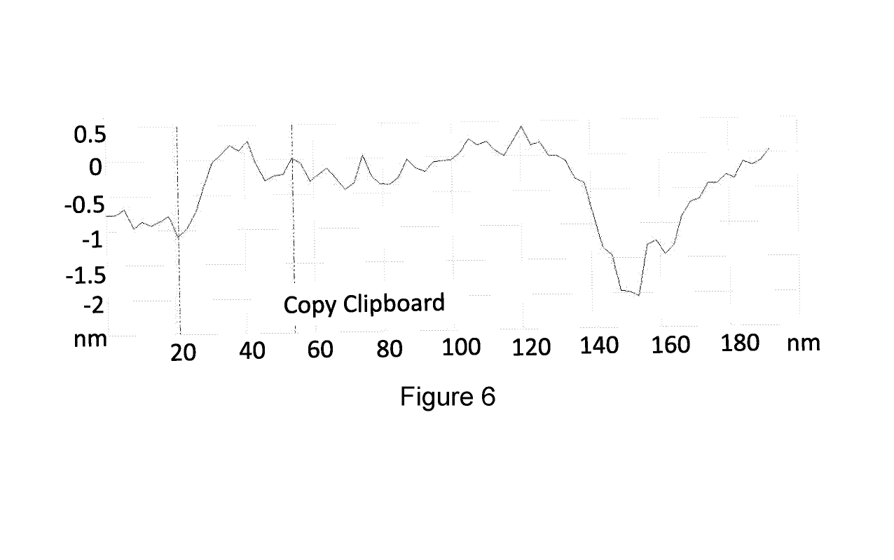

FIG. 6 is a thickness measurement diagram (b) of the hydrazine hydrate reduced graphene powders; wherein the thickness of said graphene powders is 1.109 nm;

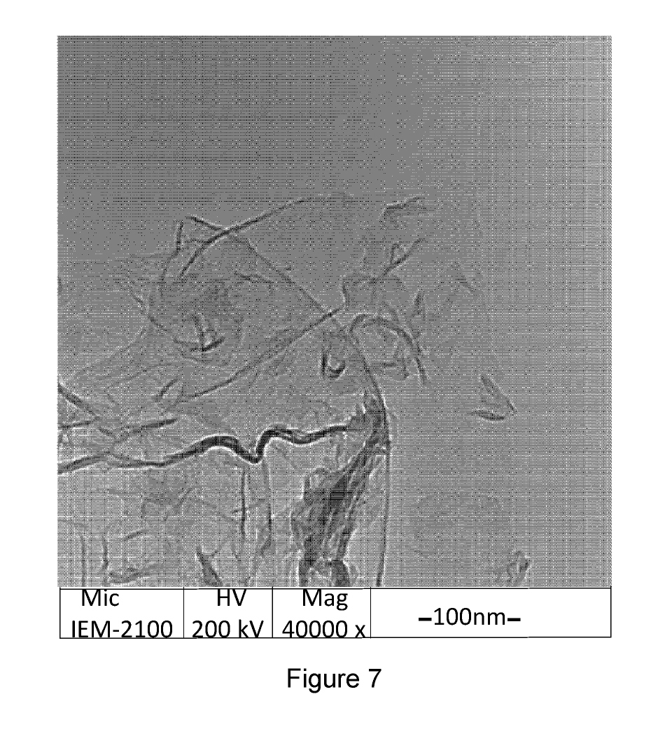

FIG. 7 is a TEM diagram of the hydrazine hydrate reduced and heat treated graphene powders which contain numbers of folds after heat treatment.

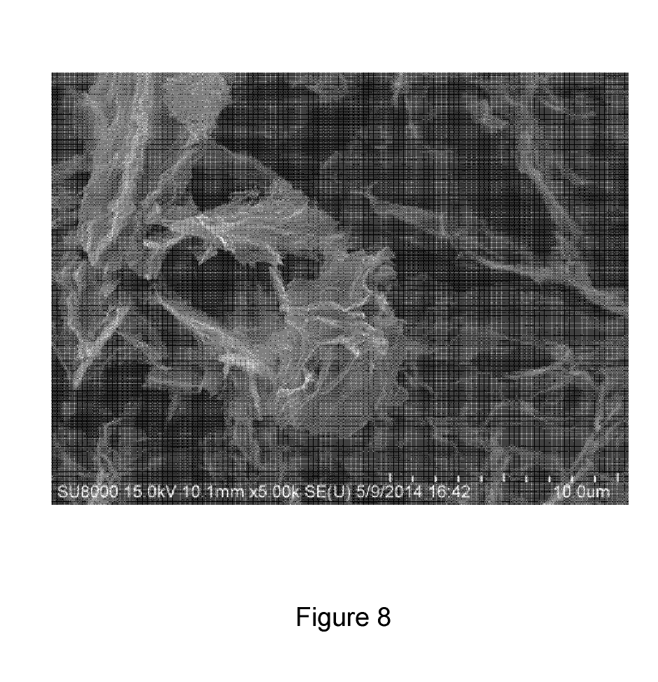

FIG. 8 is a scanning electron micrograph (SEM) diagram of the hydrazine hydrate reduced and heat treated graphene powders, which indicate that said graphene powders consist of fluffy micro nino-planes.

Although certain embodiments constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

The terms “first,” “second,” and the like, if and where used herein, do not denote any order, quantity, or importance, but rather are used to distinguish one element from another, and the terms “a” and “an” herein do not denote a limitation of quantity, but rather denote the presence of at least one of the referenced item. The modifier “approximately”, where used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

We claim:

1. A method of producing few-layer graphene powders, consisting of the steps of:
a) mixing natural graphite with sodium nitrate under an ice-cooling condition, wherein a mixture was formed;
b) adding successively high-concentrated sulfuric acid and potassium hypermanganate into said mixture for reacting;
c) adding deionized water into said mixture after reacting,
d) adding hydrogen peroxide and the deionized water into said mixture wherein a first oxidized graphite solution having a bright yellow color is prepared;
e) applying centrifuged washes which are applied alternatively with acid-washes and water-washes to said first oxidized graphite solution having the bright yellow color, wherein a second and pure oxidized graphite solution having a PH of 5-6 is prepared;
f) treating the second oxidized graphite solution by ultrasound to make an oxide of graphenes solution;
g) adding hydrazine hydrate to the oxide of the graphenes solution while stirring;
h) adding ammonia water till PH 9-10;
i) incubating the oxide of the graphenes solution, wherein a graphene colloidal solution is produced;
j) mixing said graphene colloidal solution with an electrolytic solution wherein the electrolytic solution is introduced as the coagulating floating agent, wherein said electrolytic solution is water based solutions of sulfuric acid, hydrochloric acid, sodium hydroxide, potassium hydroxide, sodium nitrate, sodium sulfate, sodium chloride, sodium carbonate, or ammonium carbonate;
k) washing said graphene colloidal solution with water; and,
l) freeze-drying the mixed solutions, wherein first graphene powders are produced.

2. The steps from claim 1, further consists of a step that after adding deionized water after the reaction, maintaining it at 90-100° C. for 20-30 minutes.

3. The steps of claim 1, further consists of steps:
a) baking the first graphene powders under a nitrogen environment;
b) grinding said first graphene powders;
c) suspending said powders by the ultrasound and in an organic solvent; and,
d) drying wherein second graphene powders are produced.

4. The electrolytic solution from claim 1, wherein its mass fraction is 1-8%.

5. The electrolytic solution from claim 4, wherein its mass fraction is 5%.

6. A method of producing few-layer graphene powders, consisting steps of:
a) mixing every 50-100 g of natural graphite with 25-50 g of sodium nitrate, wherein a mixture is formed;
b) adding 1.15-2.3 L of high-concentration sulfuric acid, and 150-300 g of potassium hypermanganate into the mixture;
c) allowing the mixture to react for 1-2 hours before raising it to 35° C. for 30-50 minutes;
d) adding 0.75-1.5 L of deionized water into the mixture;
e) Keeping the mixture at 90-100° C. for 20-30 minutes;
f) adding 0.15-0.3 L of hydrogen peroxide and 7-15 L of the deionized water to the mixture, wherein an oxidized graphite solution with a bright yellow color is produced;
g) applying alternatively acid-washes and water-washes of centrifuged washes to the oxidized graphite solution with the bright yellow color, until PH=5-6, wherein a pure oxidized graphite solution is prepared;
h) treating said pure oxidized graphite solution with ultrasound of 100-500 HZ for 0.5-2 hours to form an oxide of graphenes solution;
i) adding hydrazine hydrate then ammonia water into said oxide of the graphenes solution of 0.05-2.5 mg/mL, which results in a mixed solution having pH=9-10;
j) raising the oxide of the graphenes solution to 95° C. and incubating for 1-3 hours, wherein a graphene colloidal solution was produced;
k) mixing the graphene colloid solution with an electrolytic solution, wherein the graphene colloid solution and the the electrolytic solution have a volume-to-volume ratio of 1:1˜3, incubating at the room temperature for 0.5-2 hours;
l) allowing graphenes gradually conjugating and floating on the top of the graphene colloid solution;
m) washing the graphenes by water;
n) freeze-drying the graphenes to produce first graphene powders;
o) baking the first graphene powders at 1000-1050° C. for 2 minutes to 3 hours;
p) ultrasonic dispersing said first graphene powders with an organic solvent; and,
q) backing said first graphene powders at 50-60° C. to produce second graphene powders.

7. The electrolytic solution from claim 6, wherein said electrolytic solution is water based solutions of sulfuric acid, hydrochloric acid, sodium hydroxide, potassium hydroxide, sodium nitrate, sodium sulfate, sodium chloride, sodium carbonate, or ammonium carbonate; and a mass fraction of the electrolyte solution is 1-8%.

8. The steps of claim 6, wherein the high-concentration sulfuric acid has its mass fraction of 95-98%.

9. The steps of claim 6, further consists of a step of adding deionized water at 1:1 volume by volume ratio to the oxide of the graphenes solution having a certain concentration between 0.1-5 mg/mL, before adding hydrazine hydrate then ammonia water into said oxide of the graphenes solution.

10. The steps of claim 6, wherein the hydrazine hydrate's amount is approximately equal to 1.4 mL of the hydrazine hydrate having a mass fraction of 40%, to every 2 L of 0.5 mg/ML of the oxide of the graphenes solution; and, the ammonia water is added until the PH of said solution is between 9-10.

11. The steps of claim 10, wherein the hydrazine hydrate has the mass fraction between 40-80%, and the ammonia water has the mass fraction between 25-28%.

12. The steps of claim 6, wherein the first graphene powders are baked at a temperature raising at 2-10° C./min.

13. The steps of claim 6, wherein the organic solvent may be alcohols, ketones, or aldehydes.

14. The steps of claim 6, wherein the first graphene powders are mixed with the organic solvent at a volume-to-volume ratio of 1:1˜4, and dispersed by the ultrasound at 100˜500 HZ for 0.5˜2 hours.

15. The steps of claim 6, wherein the first graphene powders are grind until that no visible agglomerations of said graphene powders are presented.

16. The method of claim 6, wherein the first graphene powders are characterized with 2-5 layers, a carbon-oxygen ratio of 9-15, a specific surface area of 232-346 m²/g, and a conductivity of 100-403 S/m.

17. The first graphene powders of claim 16, wherein the carbon-oxygen ratio is 11.90.

18. The method of claim 6, wherein the second graphene powders are characterized with 3-7 layers, a carbon-oxygen ratio of 80-95, a specific surface area of 271-393 m²/g, and a conductivity of 1741-2766 S/m.

19. The second graphene powders of claim 18, wherein the carbon-oxygen ratio is 86.72.

20. A method of producing few-layer graphene powders, comprising step: mixing an electrolytic solution as a coagulation floating agent to a graphene colloid solution, wherein graphenes are allowed to be gradually conjugated and floated on a top thereof.

21. The step of claim 20, wherein the graphene colloid solution and the the electrolytic solution have a volume-to-volume ratio of 1:1—3.

22. The method of claim 20, wherein the electrolytic solution is water based solutions of sulfuric acid, hydrochloric acid, sodium hydroxide, potassium hydroxide, sodium nitrate, sodium sulfate, sodium chloride, sodium carbonate, or ammonium carbonate.

23. The step of claim 22, wherein the electrolyte solution has a mass fraction between 1-8%.
